(19) United States
(12) Patent Application Publication
(10) Pub. No.: US 2011/0170129 A1
(43) Pub. Date: Jul. 14, 2011

(54) PASSWORD SETTING DEVICE FOR IMAGE FORMING APPARATUS, AND PASSWORD SETTING DEVICE

(75) Inventors: Hiroshi Yamaguchi, Shizuoka-ken (JP); Toshiyuki Sato, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/987,211

(22) Filed: Jan. 10, 2011

Related U.S. Application Data
(60) Provisional application No. 61/294,149, filed on Jan. 12, 2010.

(51) Int. Cl. G06K 15/02; H04L 9/32

(52) U.S. Cl. 358/1.14; 726/6

(57) ABSTRACT

A password setting device for an image forming apparatus includes: an image reading unit which reads image information on a document; an image forming unit which forms an image on a sheet based on image data read by the image reading unit; an acceptance unit which accepts setting of a password used for user authentication; a determination unit which determines whether the password accepted via the acceptance unit violates prohibition information of the password or not; and a notification unit which notifies a user of information to prompt the user to change the password when it is determined by the determination unit that the password violates the prohibition information.

### CROSS-REFERENCE TO RELATED APPLICATION

This application is also based upon and claims the benefit of priority from U.S. provisional application 61/294,149, filed on Jan. 12, 2010; the entire contents of which are incorporated herein by reference.

### FIELD

Embodiments described herein relate generally to a technique of managing passwords of an image forming apparatus.

### BACKGROUND

Currently, improvement in the governance of a company is demanded. An IT manager in the company strictly manages the use and application of IT equipment devices used in the company to enhance or maintain security. An image forming apparatus as an IT equipment device includes ID or password-based user authentication as a security maintenance function.

However, users often use passwords that the users find easy to remember and hard to forget, such as simple strings of numbers, English words that tend to be used on PCs, or attribute information proper to individuals (for example, the users' names, employee numbers, or email addresses). The passwords of these kinds can be easily specified by a third party and may lead to impairment of security due to information leakage.

### DESCRIPTION OF THE DRAWINGS

FIG. 1 is a sectional view of an image forming apparatus.

FIG. 2 is a conceptual view of a password management system.

FIG. 3 is a data table showing attribute information.

FIG. 4 is a functional block diagram of elements of a password setting device.

FIG. 5 is a flowchart showing a password setting method.

FIG. 6 is a functional block diagram of a password setting device according to modification 1.

FIG. 7 is a flowchart showing password setting procedures according to modification 1.

### DETAILED DESCRIPTION

Generally, according to an embodiment, a password setting device for an image forming apparatus includes: an image reading unit which reads image information on a document; an image forming unit which forms an image on a sheet based on image data read by the image reading unit; an acceptance unit which accepts setting of a password used for user authentication; a determination unit which determines whether the password accepted via the acceptance unit violates prohibition information or not; and a notification unit which notifies a user of information to prompt the user to change the password when it is determined by the determination unit that the password violates the prohibition information.

Generally, according to another embodiment, a password setting device for an image forming apparatus includes: an image reading unit which reads image information on a document; an image forming unit which forms an image on a sheet based on image data read by the image reading unit; an acceptance unit which accepts setting of a password used for user authentication; a communication unit which transmits the password accepted via the acceptance unit to a management server, and receives a result of a determination as to whether the password violates prohibition information or not, from the management server; and a notification unit which notifies a user of information to prompt the user to change the password when the result of the determination received by the communication unit shows that the password violates the prohibition information.

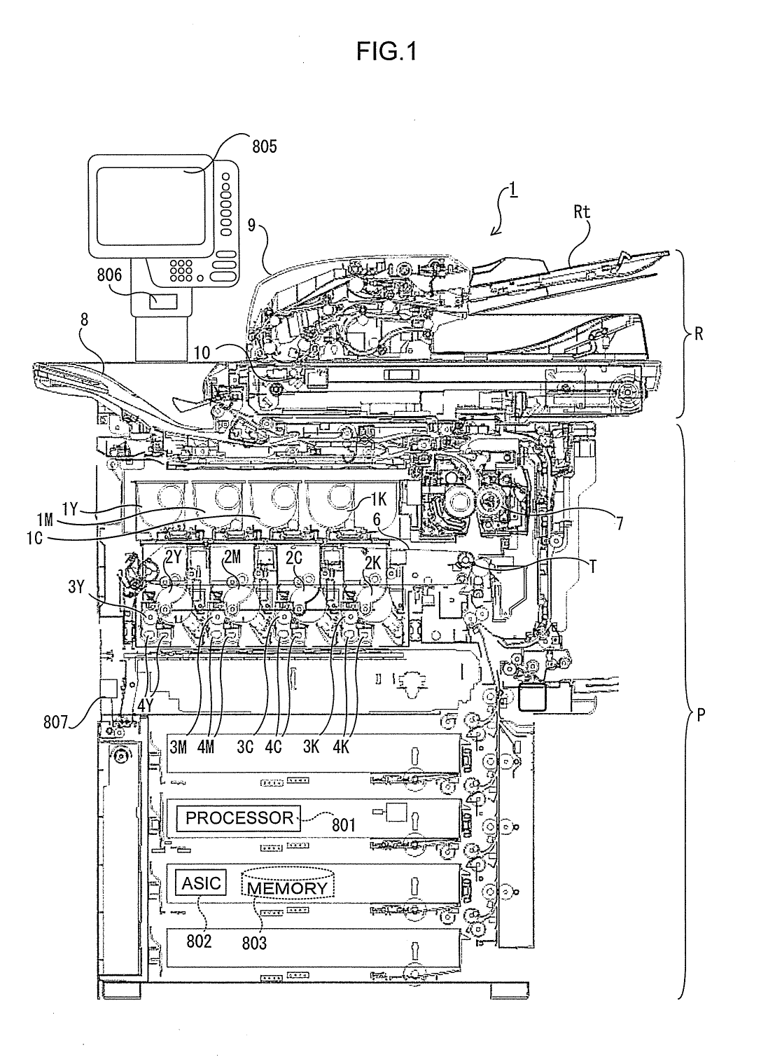

FIG. 1 is a sectional view of an image forming apparatus. Referring to FIG. 1, an image forming apparatus 1 includes an image reading unit R and an image forming unit P. The image reading unit R scans and reads an image of a sheet document or a book document.

The image forming unit P forms a developer image on a sheet based on the image read from the document by the image reading unit R or print data transmitted from an external device to the image forming apparatus 1.

The image reading unit R has an automatic document feeder (ADF) 9 which automatically carries a document to a predetermined image reading position, and reads an image of a document that is automatically carried by the automatic document feeder 9 and placed on a document tray (predetermined document placing table) Rt, or a document placed on a document table, not shown, using a scanning optical system 10.

The image forming unit P has toner cartridges 1Y to 1K, photoconductive members 2Y to 2K, developing rollers 3Y to 3K, mixers 4Y to 4K, an intermediate transfer belt 6, a fixing device 7, and a discharge tray 8.

The image forming apparatus 1 according to this embodiment also has a processor 801, an ASIC circuit 802, a memory 803, an operation display unit 805, a reading unit 806, and a communication unit 807.

The processor 801 has the role of carrying out various kinds of processing in the image forming apparatus 1 and also has the role of executing programs stored in the memory 803 and thereby realizing various functions. The memory 803 may be, for example, a random access memory (RAM), read only memory (ROM), dynamic random access memory (DRAM), static random access memory (SRAM), or video RAM (VRAM), and has the role of storing various kinds of information and programs used in the image forming apparatus 1. The memory 803 also stores password policies.

On the operation display unit 805, various kinds of setting are displayed. The operation display unit 805 may be a liquid crystal display (LCD), electronic luminescence (EL) display, plasma display panel (PDP), or cathode ray tube (CRT).

The various kinds of setting are changed by operating the operation display unit 805. The operation display unit 805 may employ a touch panel system.

The reading unit 806 reads magnetic information stored on a card. This card may be an employee card that magnetically stores ID information held by an employee.

Hereinafter, an outline of copying will be described as an example of processing in the image forming apparatus according to this embodiment.

First, a sheet picked up from a cassette by a pickup roller is supplied into a sheet carrying path. The sheet supplied in the sheet carrying path is carried in a predetermined carrying direction by plural roller pairs.

Then, an image of a sheet document including plural sheets that is continuously and automatically carried by the automatic document feeder 9 is read by the scanning optical system 10 at the predetermined image reading position.

Next, based on print data of the image read from the document by the image reading unit R, electrostatic latent images are formed on the photoconductive surfaces of the photoconductive members 2Y, 2M, 2C and 2K for transferring developer images of yellow (Y), magenta (M), cyan (C) and black (K).

Subsequently, developers stirred by the mixers 4Y to 4K in the developing devices are supplied by the developing rollers 3Y to 3K to the photoconductive members 2Y to 2K on which the electrostatic latent images are formed as described above. Thus, the electrostatic latent images formed on the photoconductive surfaces of the photoconductive members are developed.

The developer images thus formed on the photoconductive members are transferred onto the belt surface of the intermediate transfer belt 6 (so-called primary transfer). The developer images carried by the turning of the intermediate transfer belt are transferred onto the sheet that is carried, at a predetermined secondary transfer position T.

The developer images transferred onto the sheet are heated and fixed to the sheet by the fixing device 7. The sheet to which the developer images are heated and fixed is carried through the carrying pat by plural carrying roller pairs and sequentially discharged onto the discharge tray 8.

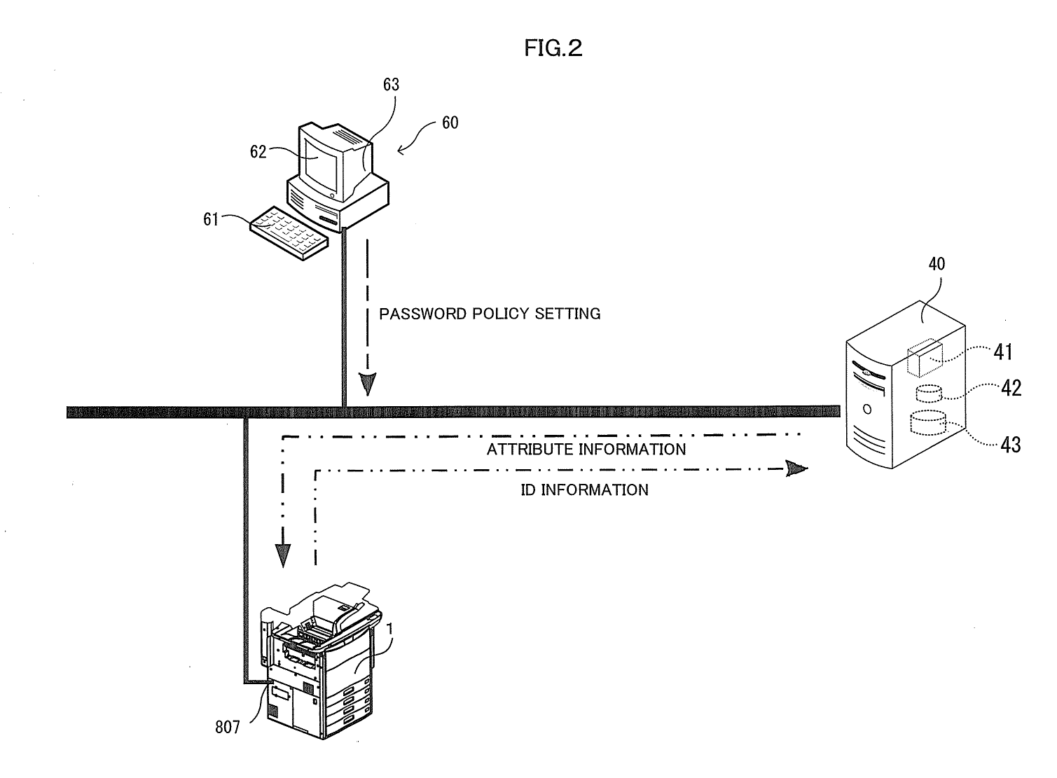

Referring to FIG. 2, a password setting device for an image forming apparatus according to this embodiment will be described. FIG. 2 is a conceptual view of a password setting device which sets a password used for user authentication in the image forming apparatus.

This password setting device has a management PC 60, the LDAP (Lightweight Directory Access Protocol) server 40 which manages attribute information and the image forming apparatus 1. The management PC 60, the LDAP server 40 and the image forming apparatus 1 are interconnected via a network. The network may be a local area network (LAN) or wide area network (WAN).

The LDAP server 40 which manages attribute information has a controller 41, a memory 42, and a hard disk drive (HDD) 43.

The controller 41 has the role of carrying out various kinds of processing in the LDAP server 40 and executes programs stored in the memory 42, thereby realizing various functions.

The memory 42 may be, for example, a random access memory (RAM), dynamic random access memory (DRAM), static random access memory (SRAM), or video RAM (VRAM).

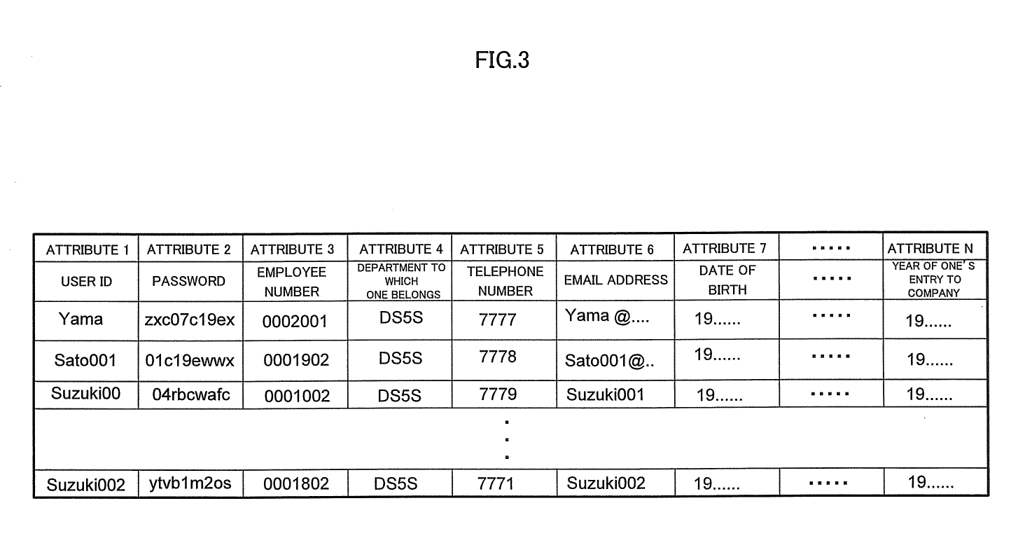

The HDD 43 stores attribute information of users. FIG. 3 is a data table showing attribute information. The attribute information is character string information with which to specify each individual, and may include user ID, currently set password, employee number, department to which one belongs, telephone number, email address, date of birth, and year of one's entry to the company.

The management PC 60 includes a keyboard 61, a display 62, and a body 63. The keyboard 61 is connected to the body 63 via a USB interface. The display 62 is connected to the body 63 via a graphic board.

The display 62 displays a management web setting screen for setting a password policy as prohibition information. Only an administrator with the right of management can log on to this management web setting screen. The administrator operates the keyboard 61 to set a password policy. The set password policy is stored in the image forming apparatus 1 via the network. The password policy may be “The use of a password including as its part a character string listed in the attribute information 1 to n (except the attribute information 2) of each user is prohibited.” In this case, if a user with a user ID “Yama” tries to set a password including this user's employee number “0002001” in the former part of the character string (for example, “0002001AAAXYZ”) or tries to set a password including the user's employee number “0002001” in the latter part of the character string (for example, “AAAXYZ0002001”), the change of the password is prohibited as violation of the password policy.

The password policy may be “The use of a password that coincides with one of the character strings listed in the attribute information 1 to n (except the attribute information 2) of each user is prohibited.”

The administrator may select the password policy from the attribute information 1 to n (except the attribute information 2). It is possible to hierarchically divide the attribute information 1 to n and use only the attribute information belonging to a specific hierarchical level as the password policy. The hierarchical division may be determined with reference to whether the division can easily specified by a third party or not. The password policy may be different from one department of the company to another.

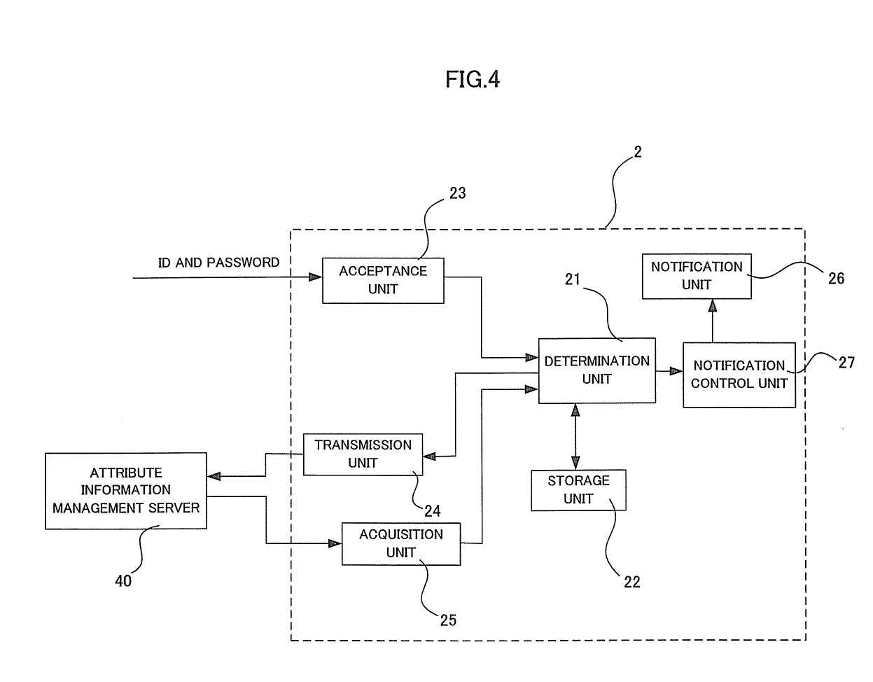

FIG. 4 is a functional block diagram of elements of the password setting device. A password setting device 2 has a determination unit 21, a storage unit 22, an acceptance unit 23, a transmission unit 24, an acquisition unit 25, a notification unit 26, and a notification control unit 27.

The determination unit 21 is responsible for controlling all of the storage unit 22, the acceptance unit 23, the transmission unit 24, the acquisition unit 25 and the notification control unit 27. The determination unit 21 decodes and executes a password setting program for password setting, stored in the storage unit 22.

The determination unit 21 may be the processor 801. The determination unit 21 may include the processor 801, and the application specific integrated circuit (ASIC circuit) 802 which executes at least a part of the processing realized by the execution of the password setting program, in a circuit-based manner. The determination unit 21 may include another processor that is different from the processor 801, and another ASIC circuit that is different from the ASIC circuit 802. The determination unit 21 may include other elements (for example, a timer) than the processor and ASIC circuit.

The acceptance unit 23 accepts a user's ID information and password. The acceptance unit 23 may be the operation display unit 805. The user inputs the user's ID information and a password that the user wants to use, on the password setting screen displayed on the operation display unit 805.

The acceptance unit 23 may be a composite element including the combination of the reading unit 806 and the operation display unit 805. The reading unit 806 magnetically acquires user ID stored on an employee card positioned at the reading position. The user inputs a password that the user wants to use, on the password setting screen displayed on the operation display unit 805. The reading unit 806 has a groove part where the employee card is to be read. A system may be employed in which the user ID is acquired as the employee card is slid within the groove part.

The acquisition unit 25 acquires the user's attribute information with which to determine whether the password that the user wants to use violates the password policy or not, from the LDAP server 40. The acquisition unit 25 may be the communication unit 807.

The transmission unit 24 transmits the ID information accepted by the acceptance unit 23 to the LDAP server 40. Transmission unit 24 may be the communication unit 807. That is, both the transmission unit 24 and the acquisition unit 25 may be the communication unit 807.

The notification unit 26 may be the operation display unit 805. When the password inputted via the acceptance unit 23 violates the password policy based on the determination by the determination unit 21, the notification control unit 27 displays a screen to request the user to re-input a password, on the notification unit 26. The notification unit 26 may prompt the user to re-input a password by audio output to the user. When the notification unit 26 is configured to prompt the user to re-input a password by audio output, the notification unit 26 may be configured as a separate unit from the operation display unit 805.

The notification control unit 27 may be the processor 801. The notification control unit 27 may include the processor 801, and the ASIC circuit 802 which executes at least a part of the processing carried out in the notification control unit 27, in a circuit-based manner. The notification control unit 27 may include another processor that is different from the processor 801, and another ASIC circuit that is different from the ASIC circuit 802. Moreover, the notification control unit 27 may include other elements (for example, a timer) than the processor and ASIC circuit.

The storage unit 22 stores the password policy set via the management PC 60, the ID information accepted by the acceptance unit 23, and the attribute information of the employee acquired from the LDAP server 40. The storage unit 22 may be the memory 803. The storage unit 22 may be another memory that is different from the memory 803. The storage unit 22 may be a composite element including the combination of the memory 803 and HDD.

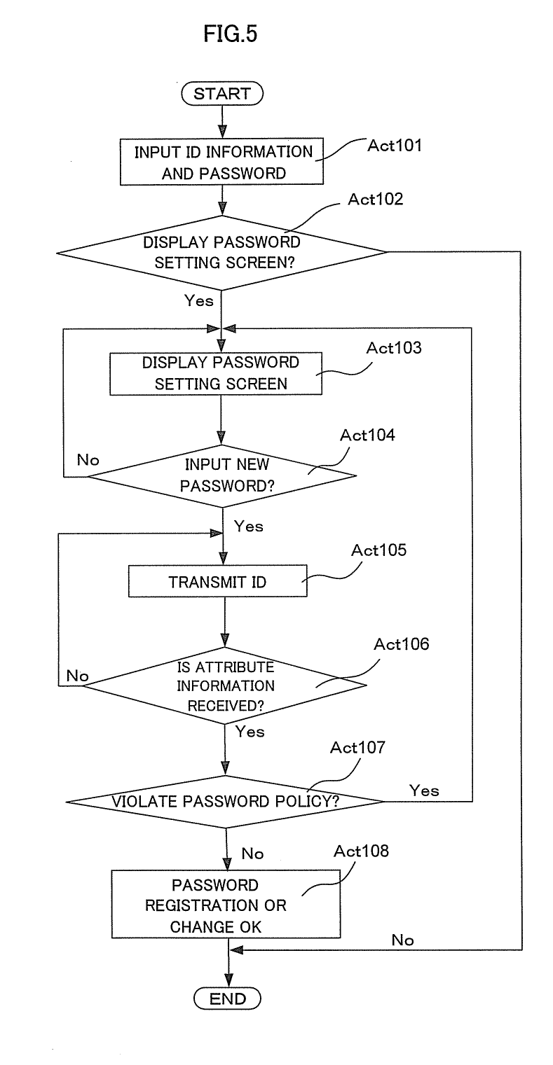

Next, a password setting or changing method will be described more specifically with reference to the flowchart of FIG. 5.

The determination unit 21 executes the processing of the following flowchart. When ID information and a password are inputted via the acceptance unit 23 in ACT 101, the determination unit 21 goes to ACT 102. In ACT 102, the determination unit 21 determines whether the password setting screen is selected or not. When the password setting screen is selected, the determination unit 21 goes to ACT 103. When the password setting screen is not selected, this flow ends.

In ACT 103, the determination unit 21 displays the password setting screen on the acceptance unit 23. The password setting screen may be a setting screen on which to set a password at the time of initial setting of password, or a change screen on which to change a password that is once set, to another password.

In ACT 104, the determination unit 21 determines whether a new password is inputted to the acceptance unit 23 or not. When a new password is inputted, the determination unit 21 goes to ACT 105.

In ACT 105, the determination unit 21 transmits the ID information accepted by the acceptance unit 23 to the LDAP server 40 via the transmission unit 24 and goes to ACT 106.

In ACT 106, the determination unit 21 determines whether the attribute information of the user is acquired by the acquisition unit 25 from the LDAP server 40 or not. The information transmitted from the LDAP server 40 may be all or a part of the attribute information of the user. When the attribute information of the user is acquired, the determination unit 21 stores this information in the storage unit 22 and goes to ACT 107.

In ACT 107, the determination unit 21 determines whether the new password inputted in ACT 104 violates the password policy or not, based on the password policy and the attribute information of the user stored in the storage unit 22. When the new password violates the password policy, the determination unit 21 returns to ACT 103 and displays the password setting screen again. When the new password does not violate the password policy, the determination unit 21 goes to ACT 108 and approves the registration of the password.

With the above method, the user does not set a password whose use is prohibited by the administrator, as a password for authentication. Therefore, security is enhanced.

### Modification 1

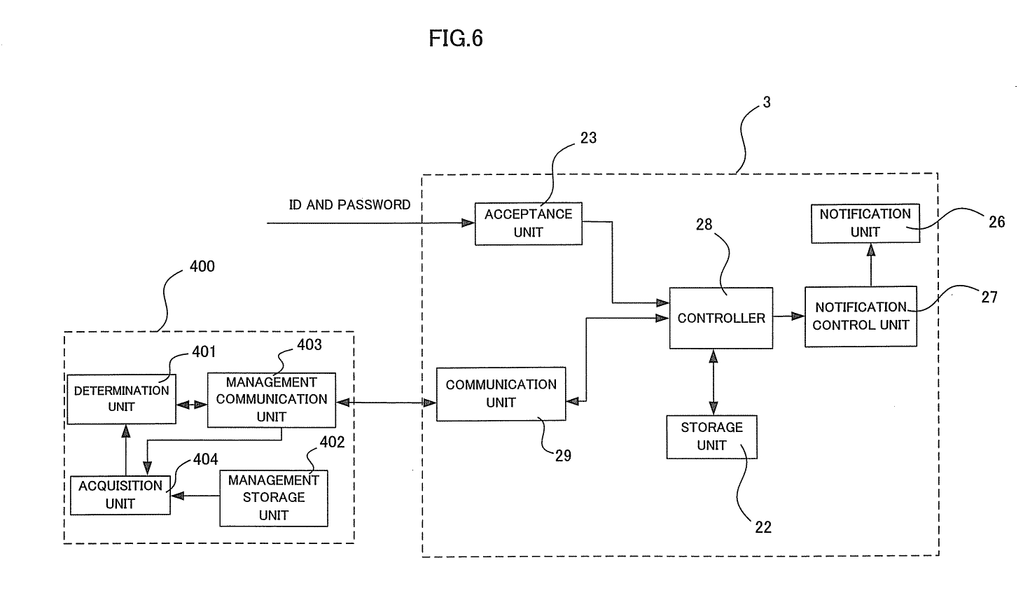

In the above embodiment, the determination unit 21 of the image forming apparatus 1 determines whether the password that the user wants to use violates the password policy or not. However, the LDAP server may perform this determination. FIG. 6 is a functional block diagram of elements of a password setting device according to modification 1. The components having the same functions as in the embodiment are denoted by the same reference numerals and will not be described further in detail.

A password setting device 3 includes the storage unit 22, the acceptance unit 23, the notification unit 26, the notification control unit 27, a controller 28, and a communication unit 29. The acceptance unit 23 accepts a user's ID information and password.

The communication unit 29 transmits the ID information and password accepted by the acceptance unit 23 to the LDAP server 400. The communication unit 29 receives the result of the determination by the LDAP server 400 as to whether the password violates the password policy or not. The communication unit 29 may be the communication unit 807.

When it is received that the password does not violate the password policy via the communication unit 29, the controller 28 stores the password and ID information inputted via the acceptance unit 23, in the storage unit 22 in association with each other.

The LDAP server 400 includes a determination unit 401, a management storage unit 402, a management communication unit 403, and an acquisition unit 404. The management storage unit 402 stores attribute information of the user and a password policy. This password policy is set via the management PC 60, as in the above embodiment. The acquisition unit 404 acquires the ID information via the management communication unit 403.

The determination unit 401 determines whether a new password received via the management communication unit 403 violates the password policy or not, based on the attribute information of the user and the password policy stored in the management storage unit 402, and transmits the result of the determination to the password setting device 3 via the management communication unit 403.

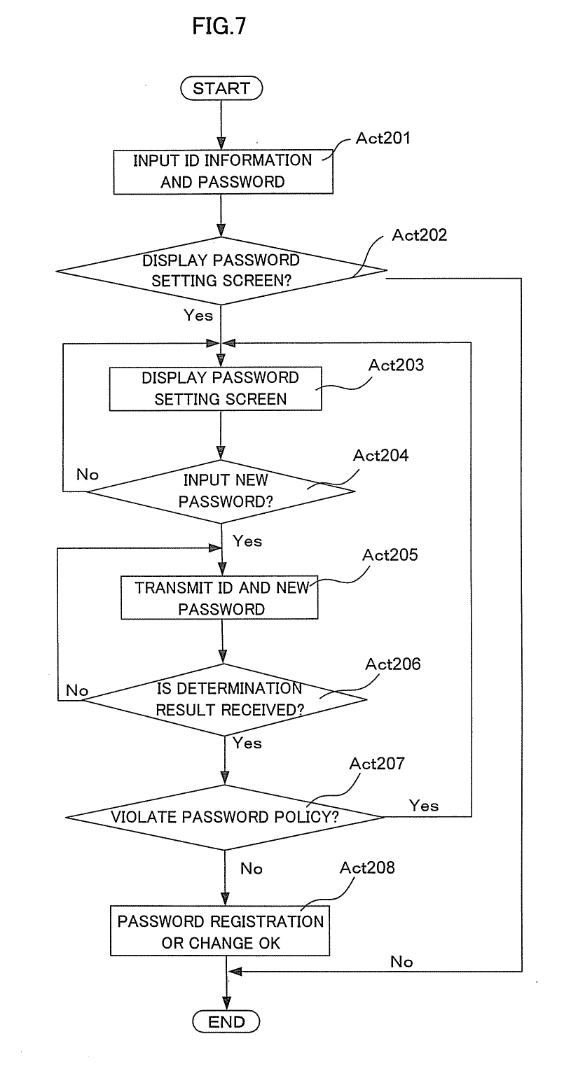

FIG. 7 is a flowchart showing password setting procedures according to modification 1. When ID information and a password are inputted via the acceptance unit 23 in ACT 201, the controller 28 goes to ACT 202. In ACT 202, the controller 28 determines whether the password setting screen is selected or not. When the password setting screen is selected, the controller 28 goes to ACT 203. When the password setting screen is not selected, this flow ends.

In ACT 203, the controller 28 displays the password setting screen on the acceptance unit 23. The password setting screen may be a setting screen on which to set a password at the time of initial setting of password, or a change screen on which to change a password that is once set, to another password.

In ACT 204, the controller 28 determines whether a new password is inputted via the acceptance unit 23 or not. When a new password is inputted, the controller 28 goes to ACT 205.

In ACT 205, the controller 28 transmits the ID information and the new password inputted via the acceptance unit 23 to the LDAP server 400 via the communication unit 29 and goes to ACT 206.

In ACT 206, the controller 28 determines whether the result of the determination is received or not, as to whether the password violates the password policy or not, from the LDAP server 400. When the result of the determination is received, the controller goes to ACT 207.

When the result of the determination is “the password does not violate the password policy” in ACT 207, the controller 28 goes to ACT 208. When the result of the determination is “the password violates the password policy”, the controller 28 returns to ACT 203.

In ACT 208, the controller 28 stores the new password and the ID information in the storage unit 22 in association with each other.

### Modification 2

The LDAP server 40 and 400 in the above embodiment and modification 1 may be a part of the image forming apparatus 1. That is, when the image forming apparatus 1 has a server, this server may manage the attribute information and password policy.

While certain embodiments have been described, these embodiments have been presented by way of example only, and are not intended to limit the scope of invention. Indeed, the novel apparatus and systems described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A password setting device for an image forming apparatus comprising:
an image reading unit which reads image information on a document;
an image forming unit which forms an image on a sheet based on image data read by the image reading unit;
an acceptance unit which accepts setting of a password used for user authentication;
a determination unit which determines whether the password accepted via the acceptance unit violates prohibition information of the password or not; and
a notification unit which notifies a user of information to prompt the user to change the password when it is determined by the determination unit that the password violates the prohibition information.

2. The device according to claim 1, further comprising a storage unit which stores the prohibition information.

3. The device according to claim 2, wherein the storage unit stores the prohibition information in association with ID information that specifies the user.

4. The device according to claim 1, further comprising an acquisition unit which acquires, from a management server which stores attribute information of the user, the attribute information associated with the prohibition information,
wherein the determination unit determines whether the password accepted via the acceptance unit violates the prohibition information or not, based on the attribute information acquired by the acquisition unit.

5. The device according to claim 4, wherein the attribute information includes character string information of at least one of user ID, employee number, department to which one belongs, telephone number, email address, date of birth, and year of one's entry to a company.

6. The device according to claim 4, wherein the acceptance unit includes an input unit to input the ID information, and
a transmission unit which transmits the ID information inputted via the input unit, to the management server.

7. The device according to claim 1, wherein when it is determined by the determination unit that the password accepted via the acceptance unit violates the prohibition information, the notification unit displays a screen to prompt the user to input a password again.

8. The device according to claim 1, wherein when it is determined by the determination unit that the password accepted via the acceptance unit does not violate the prohibition information, the determination unit stores the password information in the storage unit.

9. A password setting device comprising:
an acceptance unit which accepts setting of a password used for user authentication;
a determination unit which determines whether the password accepted via the acceptance unit violates prohibition information of the password or not; and
a notification unit which notifies a user of information to prompt the user to change the password when it is determined by the determination unit that the password violates the prohibition information.

10. The device according to claim 9, further comprising a storage unit which stores the prohibition information.

11. The device according to claim 10, wherein the storage unit stores the prohibition information in association with ID information that specifies the user.

12. The device according to claim 9, further comprising an acquisition unit which acquires, from a management server which stores attribute information of the user, the attribute information associated with the prohibition information,
wherein the determination unit determines whether the password accepted via the acceptance unit violates the prohibition information or not, based on the attribute information acquired by the acquisition unit.

13. The device according to claim 12, wherein the attribute information includes character string information of at least one of user ID, employee number, department to which one belongs, telephone number, email address, date of birth, and year of one's entry to a company.

14. The device according to claim 12, wherein the acceptance unit includes an input unit to input the ID information, and
a transmission unit which transmits the ID information inputted via the input unit, to the management server.

15. The device according to claim 9, wherein when it is determined by the determination unit that the password accepted via the acceptance unit violates the prohibition information, the notification unit displays a screen to prompt the user to input a password again.

16. The device according to claim 9, wherein when it is determined by the determination unit that the password accepted via the acceptance unit does not violate the prohibition information, the determination unit stores the password information in the storage unit.

17. A password setting device for an image forming apparatus comprising:
an image reading unit which reads image information on a document;
an image forming unit which forms an image on a sheet based on image data read by the image reading unit;
an acceptance unit which accepts setting of a password used for user authentication;
a communication unit which transmits the password accepted via the acceptance unit to a management server, and receives a result of a determination as to whether the password violates prohibition information or not, from the management server; and
a notification unit which notifies a user of information to prompt the user to change the password when the result of the determination received by the communication unit shows that the password violates the prohibition information.

18. The device according to claim 17, wherein the management server includes:
a storage unit which stores the attribute information and the prohibition information associated with the attribute information; and
a determination unit which determines whether the password received from the communication unit violates the prohibition information or not, based on the attribute information.

19. The device according to claim 18, wherein the attribute information includes character string information of at least one of user ID, employee number, department to which one belongs, telephone number, email address, date of birth, and year of one's entry to a company.
